(19) United States
(12) Patent Application Publication
(10) Pub. No.: US 2006/0159787 A1
(43) Pub. Date: Jul. 20, 2006

(54) Product with insect-repellent and/or insecticidal activity and method of production thereof

(75) Inventor: Giuseppina Cerea, Rozzano (Milano) (IT)

Correspondence Address: AKERMAN SENTERFITT, P.O. BOX 3188, WEST PALM BEACH, FL, 33402-3188, US

(73) Assignee: Vomm Chemipharma S.r.l., Rozzano (Milano) (IT)

(21) Appl. No.: 11/334,167

(22) Filed: Jan. 18, 2006

(30) Foreign Application Priority Data
Jan. 18, 2005 (IT) MI2005A 000049

(51) Int. Cl. A01N 65/00

(52) U.S. Cl. 424/769

(57) ABSTRACT

An insect-repellent and/or insecticidal product is described obtained by concentration of by-product vegetable water from olive milling, characterized in that it has a dry matter content of 10% or higher and a pH of 5 or higher; a method for the preparation of such a product is also described comprising the step of making a continuous stream of said vegetable water flow in the state of a turbulent thin layer, in contact with a heated wall of a turbo-concentrator comprising a horizontal-axis cylindrical tubular body (1), having an inlet opening (5) for said vegetable water and a final product discharge opening (7), a heating jacket (4) to bring the inner wall of said tubular body at a pre-determined temperature, and a bladed rotor (8), rotatably supported in the cylindrical body (1).

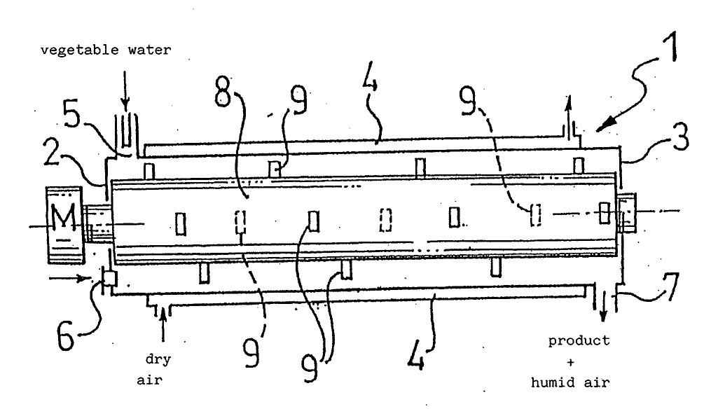

The present invention generally concerns the food and agriculture industry sector.

In particular, the invention concerns a product capable of preventing and combating insect-caused crop infestations, with particular, though not exclusive, reference to olive fly infestations to olive plantations, and a method for its preparation.

It is well-known that the olive fly represents a serious threat, at times even an actual scourge, to olive plantation of the Mediterranean. Following an olive fly infestation, the olive harvest suffers a dramatic reduction in terms of end yield of oil and the quality of the oil obtained is often irreversibly compromised, owing to its high acidity and its high peroxide content.

It has thus become a standard and often necessary procedure to carry out a preventive, and also during the course of the infestation, treatment of the olive trees with pest control agents belonging to the class of the organophosphorous compounds, such as, for example, rogor and malathion.

Such treatments, as well as exhibiting decreasing efficacy, due to the developing resistance to them exerted by the olive fly and its larvae, also bring about an impoverishment of the quality of the final oil, not least because the latter contains within it an amount of the above-mentioned pest control agents which is proportional to the quantities that have been used for the treatment of the olive trees.

It is for this very reason that it is becoming increasingly important, even from a quantitative point of view, to produce olive oil using organic or bio-dynamic farming techniques. However, this latter sector, indeed, lacks an established method for the prevention and the fight against the olive fly that is compatible with organic farming practices, that is, that does not include treatments using chemical substances.

The problem underlying the present invention was thus that of providing a method to prevent and fight olive fly infestations that would be more effective than conventional treatments using organophosphoric insecticides and that would also be compatible with organic farming requirements.

Such a problem has been solved, according to the invention, by providing an insect-repellent and/or insecticide product obtained by concentration of the by-product vegetable water from olive milling, characterized by a dry matter content of 10% or higher and a pH of 5 or higher.

The concentration of said vegetable water may be carried out by a number of techniques and may advantageously be combined with a heat treatment. Preferably, concentration is carried out by heating, conveniently at a temperature of 100° C. or higher.

The product according to the invention preferably has a dry matter content comprised between 20 and 50% and a pH of 6 or higher and can advantageously be obtained by a method comprising the step of making a continuous stream of said vegetable water flow in the state of a turbulent thin layer, in contact with a heated wall.

In a preferred embodiment of the present invention, a turbo-concentrator is used as the concentration apparatus.

Among such machines, the one produced and marketed by VOMM IMPIANTI E PROCESSI-Milan (Italy) has been found to be particularly suitable and convenient. Such a machine essentially comprises a horizontal axis cylindrical tubular body, closed at the opposed ends by end walls, having openings for the introduction of vegetable water and of a co-current stream of dry air, a heating jacket to bring the inner wall of said tubular body to a pre-determined temperature, a bladed rotor, rotatably supported in the cylindrical tubular body, where it is made to rotate at a peripheral speed comprised between 15 and 50 m/s.

By using a turbo-concentrator of the above-mentioned type, the method of production of the product according to the present invention is characterized in that it comprises the steps of:
feeding a continuous stream of vegetable water in said turbo-concentrator, wherein the bladed rotor is made to rotate at peripheral speeds comprised between 15 and 50 m/s,
centrifuging said vegetable water to form a turbulent and dynamic thin layer wherein the water is maintained in a state of high turbulence by the blades of said bladed rotor,
conveying said dynamic turbulent thin layer towards the discharge opening of the turbo-concentrator, making it flow in substantial contact with the heated wall thereof towards said discharge opening,
continuously discharging a stream of said product.

Advantageously, a stream of hot dry air is fed into the turbo-concentrator co-currently to the vegetable water; in this way, the speed of vapor removal is increased, thus reducing the required residence time of the stream in the concentrating apparatus.

The above-mentioned stream of dry air preferably has a flow rate of up to 10 Nm³ of air per liter of evaporated water.

The inner wall of the turbo-concentrator is preferably kept at a temperature comprised between 100° and 150° C.

By using the product according to the present invention, the infestation of olive trees by the olive fly is prevented and/or combated by diluting the above-mentioned product in water to achieve a dry matter content comprised between 8 and 15% and uniformly distributing it on the tree foliage.

The prevention of the olive fly infestation is achieved by spraying the plants during a vegetative period anterior to the formation of the fruits or also shortly after the formation of the fruits and repeating the treatment at pre-determined intervals, similar to those used in association with conventional organophosphoric pesticides.

The treatment using the product according to the invention maintains a good efficacy even when carried out at a time following the infestation by the olive fly, thus proving to exhibit not only an insect-repellent activity but also an insecticidal activity.

Although the product according to the invention has so far been tested on a large scale only on olive fly infestations, the preliminary laboratory data and small scale tests data collected show that the insect-repellent and insecticidal activity is exerted also towards other pests of various crops.

The present invention will now be described in greater detail with reference, for illustrative and non-limiting purposes, to the preparation of the product according to the invention using the apparatus schematically illustrated in the one annexed drawing and the use of the product according to the invention to combat olive fly infestations of olive trees.

### PREPARATION OF A PRODUCT ACCORDING TO THE INVENTION

Olive vegetable water obtained as by-product from an olive-mill for olive pressing, having a dry matter content of about 3%, a pH of about 4.5 and a light green, slightly fluorescent color, was concentrated in a turbo-concentrator by VOMM Impianti e Processi, as described above and as schematically illustrated in the annexed Figure.

With reference to such Figure, the turbo-concentrator used for the production of the product according to the invention comprises a cylindrical tubular body 1, closed at the opposed ends by end walls 2, 3 and having a co-axial heating jacket 4 through which a fluid, for example diathermic oil, is circulated, to maintain the inner wall of the body 1 at a pre-determined temperature.

The tubular body 1 has an inlet opening 5 for the vegetable water to be concentrated, an opening 6 for the flow of hot dry air, and a final product discharge opening 7.

In the tubular body 1, a bladed rotor 8 is rotatably supported, the blades 9 of which are helicoidally arranged and are oriented so as to centrifuge and simultaneously convey towards the outlet the vegetable water to be concentrated.

An engine M is provided to drive the bladed rotor at variable speeds.

By using such turbo-concentrator, the above-mentioned vegetable water was continuously stream-fed through the inlet opening 5 at a flow rate of 100 l/h, while a co-current stream of dry air at a temperature of 100° C. having a flow rate of 300 Nm³/h was fed through opening 6. The heating jacket 4 was thermostated at a temperature of 120° C.

The bladed rotor 8, rotating at a peripheral speed of 40 m/s, centrifuged the vegetable water against the turbo-concentrator wall, where it formed a turbulent and dynamic thin layer.

After an average residence time of about 5 minutes inside the turbo-concentrator, a continuous stream of a product consisting of concentrated vegetable water having a dry matter content of about 30%, a pH of about 6 and a brown color, was discharged through the discharge opening 7. Simultaneously, the air stream-fed into the turbo-concentrator released, through the above-mentioned discharge opening, the steam formed following the heat treatment of the vegetable water.

### APPLICATION OF A PRODUCT ACCORDING TO THE INVENTION

The concentrated product obtained was used, following dilution in water to achieve a solution having a dry matter content of about 10%, to treat olive trees, of the oglialora cultivar, of about 100 years of age.

Two plants were treated with the solution by uniformly distributing the solutions on the foliage. Four treatments were carried out at intervals of 8 days from each other, each time using 4 liters of solution per plant.

50 olives were taken from each treated plant one day before the last treatment and the same number of olives was taken from nearby non-treated plants, used as controls.

Another sampling of 50 olives from each plant and from control plants was carried out five days after the last treatment.

From observations of the collected olives under the stereoscopic binocular microscope, the following results were obtained:

Treated samples taken one day before the last treatment
1 eclosion hole
1 oviposition cavity

Controls:
9 oviposition cavities
1 egg
3 eclosion holes
2 dead larvae
2 pupae
2 small larvae

Treated samples taken five days after the last treatment:
2 eclosion holes
2 blocked old fertile punctures

Controls:
8 eclosion holes
6 large larvae
19 small larvae
3 pupae
4 tunnels
1 blocked puncture.

The collected data can be summarized by the following table:

| | 10% d.m. solution | Controls |
|---|---|---|
| | Active infestation % | Active infestation % |
| 1 d before the last treatment | 4% | 40% |
| 5 d after the last treatment | 8% | 82% |

From the table it can be seen that the treatment using the product according to the invention having about a 10% dry matter content has conferred significant protection to the plants from olive fly infestation, thus proving its insect-repellent and insecticidal activity.

The olives picked from the trees treated with the product according to the present invention were further subjected to milling with a lab-scale mill and compared to olives picked from the nearby non-treated (control) trees.

The oil obtained from the treated and the control olives was then analyzed for the determination of acidity and peroxides.

The acidity of the oil obtained from the treated olives, expressed as % of free oleic acid, was 0.10 whereas the acidity of the oil obtained from the control olives was 0.20.

The peroxide content of the oil obtained from the treated olives was 1.30 meq O₂/kg and that of the oil obtained from the control olives was 2.40 meq O₂/kg.

These results show that the treatment of the olive trees with the product according to the invention has also determined an improvement of the organoleptic/nutritional characteristics of the oil (dramatic reduction of the acidity) and a highly protective effect against free radicals and oxidative processes (peroxide content practically halved compared to the controls).

Finally, the polyphenol content of the oil obtained from the olives treated with the product according to the invention was high and comparable with that of high quality extra-virgin oils.

1. Insect-repellent and/or insecticidal product obtained by concentration of by-product vegetable water from olive milling, which has a dry matter content of 10% or higher and a pH of 5 or higher.

2. Product according to claim 1, obtained by concentration and heat treatment of said vegetable water.

3. Product according to claim 1, obtained by concentration under heating of said vegetable water.

4. Product according to claim 3, having a dry matter content comprised between 20 and 50% and a pH of 6 or higher.

5. Product according to claim 4, which is obtained by concentrating the vegetable water at a temperature of 100° C. or higher.

6. Method for the preparation of a product according to claim 3, comprising the step of making a continuous stream of said vegetable water to flow in the state of a turbulent thin layer, in contact with a heated wall.

7. Method for the preparation of a product according to claim 5, comprising the step of making a continuous stream of said vegetable water to flow in the state of a turbulent thin layer, in contact with a heated wall.

8. Method according to claim 6, comprising the steps of:
feeding a continuous stream of said vegetable water in a turbo-concentrator comprising a horizontal-axis cylindrical tubular body (1), having an inlet opening (5) for said vegetable water and a final product discharge opening (7), a heating jacket (4) to bring the inner wall of said tubular body at a pre-determined temperature, a bladed rotor (8), rotatably supported in the cylindrical body (1) where it is made to rotate at peripheral speeds variable between 15 and 50 m/s,
centrifuging said vegetable water to form a turbulent and dynamic thin layer wherein the water is maintained in a state of high turbulence by the blades (9) of said bladed rotor (8),
conveying said dynamic turbulent thin layer towards the discharge opening (7) of the turbo-concentrator, making it flow in substantial contact with the heated wall thereof towards said discharge opening,
continuously discharging a stream of said product.

9. Method according to claim 8, wherein the inner wall of said tubular body is kept at a temperature comprised between 100° and 150° C.

10. Method according to claim 9, wherein a stream of hot dry air is fed into said turbo-concentrator co-currently to the continuous stream of said vegetable water.

11. Method of preventing and/or combating infestation of plants by disease-transmitting insects, comprising the step of applying on said plants the product according to claim 1 after having brought the dry matter content thereof to a value comprised between 8 and 15% possibly by dilution with water.

12. Method of preventing and/or combating infestation of plants by disease-transmitting insects, comprising the step of applying on said plants the product according to claim 5 after having brought the dry matter content thereof to a value comprised between 8 and 15% possibly by dilution with water.

13. Method of preventing and/or combating olive fly infestation of olive trees comprising the step of uniformly applying the product according to claim 1 on the foliage of said trees after having brought the dry matter content thereof to a value comprised between 8 and 15% possibly by dilution with water.

14. Method of preventing and/or combating olive fly infestation of olive trees comprising the step of uniformly applying the product according to claim 5 on the foliage of said trees after having brought the dry matter content thereof to a value comprised between 8 and 15% possibly by dilution with water.
